(19) United States
(12) Patent Application Publication
(10) Pub. No.: US 2007/0063162 A1
(43) Pub. Date: Mar. 22, 2007

(54) Compressible bladder and method of relieving pressure in a chamber

(75) Inventor: Damon Eric Woodson, Macon, GA (US)

Correspondence Address: TROUTMAN SANDERS LLP, 600 PEACHTREE STREET , NE, ATLANTA, GA, 30308, US

(73) Assignee: The Southern Company, Atlanta, GA (US)

(21) Appl. No.: 11/523,386

(22) Filed: Sep. 19, 2006

Related U.S. Application Data
(60) Provisional application No. 60/718,933, filed on Sep. 20, 2005.

(51) Int. Cl. F16K 39/00

(52) U.S. Cl. 251/281

(57) ABSTRACT

The present invention relates to a compressible bladder for easing the process of opening a pressure-sealed chamber. The valve comprises a valve body having an interior, wherein media is adapted to flow therethrough; a bonnet defining a chamber carried by the valve body; a plug having a first position and a second position, wherein the plug prohibits media to flow through the valve body in the first position, and the plug does not prohibit media to flow through the valve body in the second position; an elongated stem adapted to move the plug between the two positions, wherein the stem is positioned between the valve body and the bonnet; and a compressible bladder positioned in the chamber of the bonnet adapted to compress upon an increase of pressure within the chamber of the bonnet.

### CROSS REFERENCE TO RELATED APPLICATION

This application claims priority of U.S. Provisional Patent Application No. 60/718,933, filed 20 Sep. 2005, the entire contents of which is hereby incorporated by reference.

### BACKGROUND

1. Field of the Invention

The present invention relates to bladders and, in particular, to relieving pressure in a chamber by providing a compressible bladder in the chamber.

2. Description of Related Art

Valves are devices adapted to start, stop, or regulate flow of media, i.e., fluid or gas, in a pipeline. Commonly, gate valves are implemented to regulate media flow.

FIGS. 1-2 illustrate conventional valves. A conventional valve 100 includes a handwheel 105, a stem 110, a packing 115, a bonnet 120 defining a chamber 140, a disc or plug 125, and a valve body 130. The valve 100 can be a gate valve, and is the device which can start, stop, or regulate media flow, typically in a pipeline.

The handwheel 105 (often referred to a “wheel” or “handle”) can be rotatable. As the handwheel 105 is rotated, it enables the stem 110 to move the disc 125 downwardly toward the valve body 130. Alternatively, rotating the handwheel 105 in the opposite direction enables the stem 110 to move the disc 125 upwardly away from the valve body 130.

The packing 115 is adapted to secure media housed in the valve body 130 and the chamber 140. The packing 115 is often a malleable compound that enables a seal of the valve 100 to be tightened, and typically surrounds the stem 110. The characteristics of the packing 115 preferably include it to be both strong and hard enough to hold the pressure of fluid or gas in the valve 100, yet soft enough to be compressed into shape. The compression on the packing 115 prohibits valve 100 leakage.

The chamber 140 is formed by bonnet 120 and can house the disc 125 when the disc 125 does not plug the valve body 130.

The handwheel 105 is connected to the stem 110, which is connected to the disc 125. As the handwheel 105 is rotated the disc 125 is either inserted or removed from the valve body 130, depending on the rotation of the handwheel 105.

When the disc 125 is absent from the valve body 130, or not plugging, the disc 125 is housed in the chamber 140 of the bonnet 120. As the disc 125 is inserted into the valve body 130, media enters the chamber 140. Eventually, the handwheel 105 is rotated enough to place the disc 125 in the valve body 130. Once the disc 125 is fully inserted into the valve body 130, the chamber 140 is sealed. Typically, the media that entered the chamber 140 fills the chamber 140 completely.

As the temperature in the chamber 140 changes, the pressure within the chamber 140 also changes. As the chamber temperature rises, the pressure rises. The pressure in the chamber 140 can be so great that it is nearly impossible for an operator to move the handwheel 105, in an effort to remove the disc 125 from the valve body 130. The chamber 140 needs to be regulated to permit adjustment of the disc 125.

There are two conventional methods of releasing the pressure in the chamber. A first requires drilling a hole in the chamber to bleed off part of the pressurized fluid or gas housed in the chamber. This is dangerous, depending on the media in the valve body, and compromises the chamber, as it is not pressure-sealed. A second conventional method requires a relief valve that will allow control of the bleeding of the media from the chamber. This method decreases the seal of the disc within the valve body.

A method of a fluid regulating valve is described in U.S. Pat. No. 2,051,484 to Jordan (the '484 patent). The '484 patent describes a pressure regulating valve. The pressure regulating valve is a method of varying pressure in a system by using a spring. In this description, fluid also moves outside the valve, which can be dangerous.

Another method of a fluid regulating valve is described in U.S. Pat. No. 2,511,342 also to Jordan (the '342 patent). This method is an improvement over the '484 patent. The device modulates pressure through media flow. The method requires fluid to flow from one chamber to another, enabling pressure control.

What is needed, therefore, is a device enabling pressure control of a chamber of a valve. Preferably, the device enabling pressure control of the chamber will not require a hole in the chamber for media to bleed therefrom.

### SUMMARY

The present invention relates to a compressible bladder adapted to compress based on an increase in pressure in a sealed chamber. In one embodiment, the compressible bladder minimizes pressure in a closed valve, the valve including a valve body, a bonnet defining a chamber, and a stem adaptable to travel within the bonnet. The compressible bladder includes a shell and a connection assembly. The shell defines a hollow interior, and is adapted to compress based on a predetermined amount of pressure within the chamber. The interior of the shell is preferably filled with compressible media. The connection assembly secures the shell within the chamber of the bonnet in a position as to not interfere with movement of the stem.

In another embodiment of the present invention, the compressible bladder is preferably positioned in a valve. A valve includes a valve body, a bonnet, a plug, an elongated stem, and the compressible bladder. The valve body of the valve includes an interior, wherein media is adapted to flow therethrough. The bonnet defines a chamber carried by the valve body. The plug of the valve has a first position and a second position, wherein the plug prohibits media to flow through the valve body in the first position, and the plug does not prohibit media to flow through the valve body in the second position. Further, the elongated stem of the valve is adapted to move the plug between the two positions, wherein the stem is positioned between the valve body and the bonnet. The compressible bladder is positioned in the chamber of the bonnet, and is adapted to compress upon an increase of pressure within the chamber of the bonnet.

In yet another embodiment of the present invention, a method of relieving pressure in a chamber is described. The method of minimizing pressure in a chamber comprises providing a compressible bladder adapted to compress upon an increase in pressure; pressurizing a sealed chamber; and compressing the compressible bladder in the pressurized sealed chamber based on an increase in pressure.

Further features of the invention, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

FIG. 1 illustrates a cross-sectional view of a conventional valve.

FIG. 2 illustrates a perspective, partial cross-sectional view of a conventional valve.

FIG. 3 illustrates a cross-sectional view of the conventional valve having the compressible bladder, in accordance with an exemplary embodiment of the present invention.

FIG. 4 illustrates a perspective view of the compressible bladder, in accordance with an exemplary embodiment of the present invention.

FIG. 5 illustrates a cross-sectional view along A-A of FIG. 4 depicting the compressible bladder in an uncompressed state, in accordance with an exemplary embodiment of the present invention.

FIG. 6 illustrates a cross-sectional view along A-A of FIG. 4 depicting the compressible bladder in a compressed state, in accordance with an exemplary embodiment of the present invention.

FIG. 7 illustrates a cross-sectional view of a compressible bladder in an uncompressed state secured to a chamber, in accordance with another exemplary embodiment of the present invention.

FIG. 8 illustrates a cross-sectional view of the compressible bladder in a compressed state secured to the chamber, in accordance with an exemplary embodiment of the present invention.

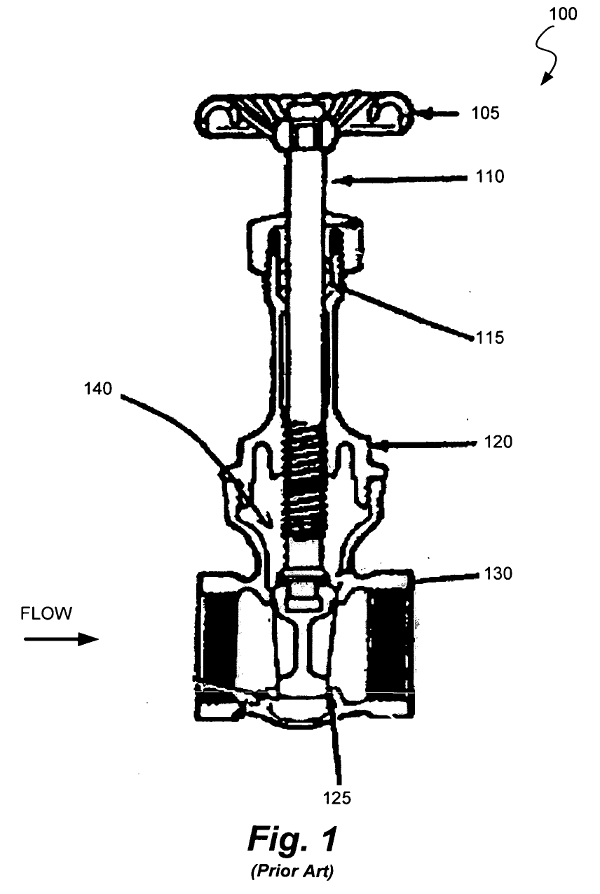

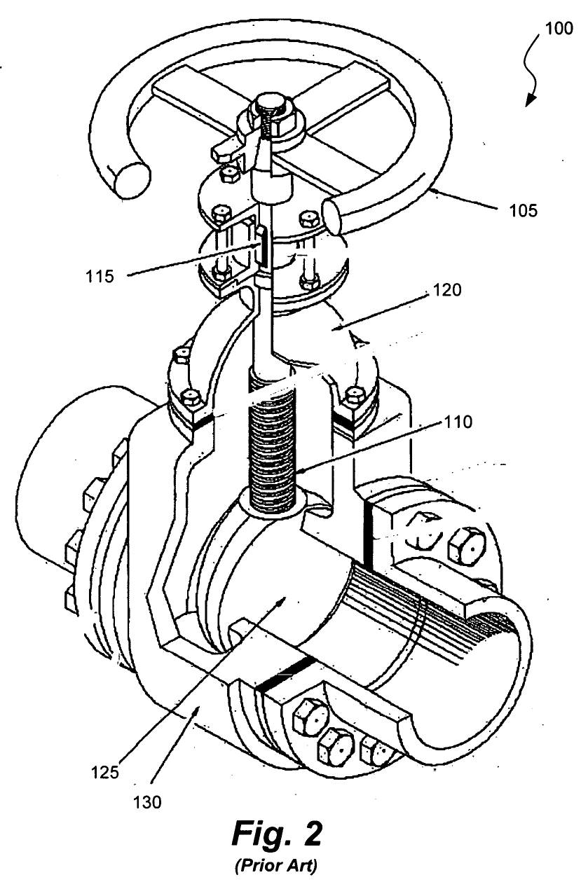

### DETAILED DESCRIPTION

To facilitate an understanding of the principles and features of the invention, it is explained hereinafter with reference to its implementation in an illustrative embodiment. In particular, the invention is described in the context of being a compressible bladder in a valve for easing the task of opening a valve after an increase in pressure makes it difficult to open the valve.

The invention, however, is not limited to its use as a compressible bladder in a valve. Rather, the invention can be used when a device for easing the task of opening/closing an apparatus after an increase in pressure occurs as is desired, or necessary. Thus, the device described hereinafter as a compressible bladder in a valve can also find utility as a device for other applications, beyond that of a valve.

Additionally, the material described hereinafter as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Referring now to figures, wherein like references numerals represent like parts throughout the view, the present compressible bladder in a valve will be described in detail.

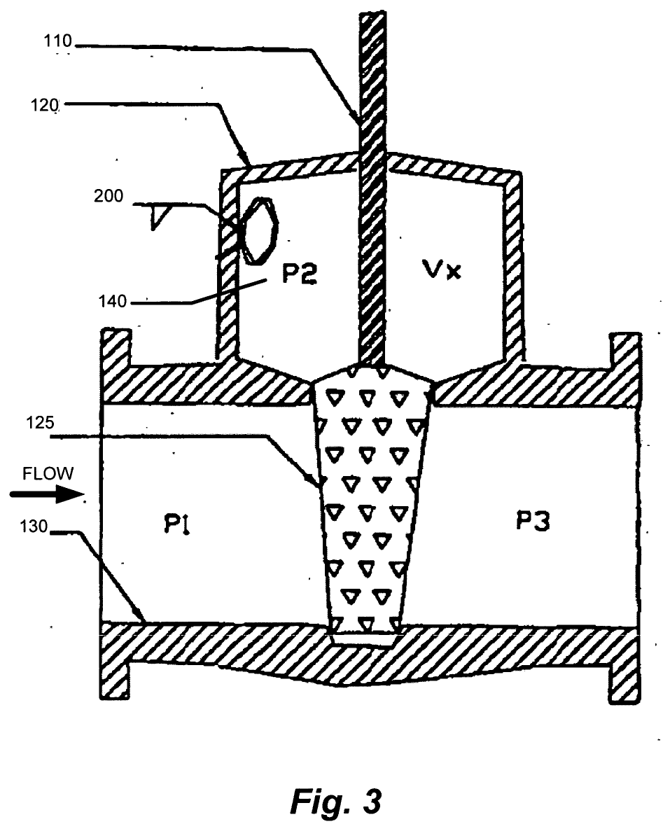

FIG. 3 illustrates a cross-sectional view of the valve having a compressible bladder positioned therein, in accordance with an exemplary embodiment of the present invention. This figure illustrates the valve body 130 plugged by the disc 125. The direction of media flow is indicated by the arrow. When the valve body 130 is plugged, the bonnet 120 forms the sealed chamber 140. Consequently, different pressure levels are generated throughout the valve 100.

For instance, when the disc 125 is in an open position, the pressure in the chamber 140 is similar to the pressure in the valve body 130, i.e., P1=P2=P3. When the stem 110 is stroked such that the disc 125 is placed into the valve body 130 (i.e., inhibiting flow of media in the valve body 130), the area P2 becomes bottled-up or sealed. Accordingly, the media in chamber 140, or area P2, can be pressure-sealed when the plug 125 stops media flow in the valve body 130.

When the chamber 140 becomes sealed, media is captured therein. As a result, a change in pressure or temperature can cause the media sealed in the chamber 140 to expand or contract. For example, if the temperature rises, or area P2 heats up, the pressure in area P2 will increase causing the media to expand. This pressure increase is due to the media not having an ability to escape. Consequently, when an operator attempts to raise the disc 125 via the stem 110, and thus open the valve body 105, the pressure can be so great that raising the disc 125 can be overwhelmingly difficult.

There are two standard approaches to release pressure in the chamber 140. The first requires drilling a hole in the reverse flow seat to bleed off part of the media housed in the chamber 140. This approach degrades the sealing capability of the valve 100, and makes the chamber 140 inferior, and not completely pressure sealed. The chamber 140 is seated to flow in one direction. Further, this first approach decreases the seal of the disc 125 within the valve body 105, and can create dangerous situations with bleeding the media from the chamber 140, for the media can be a toxic chemical. A second approach to release pressure in the chamber requires adding a pressure boundary to the chamber 140 and attaching a relief valve that can allow bleeding off of the media from a hole in the chamber 140 that the relief valve covers. This approach increases danger, as a connection can ultimately leak or fail. This possible leakage could be extremely dangerous if the media housed in the chamber 140 is hazardous to humans.

FIG. 3 illustrates the compressible bladder 200 positioned in the chamber 140. As the pressure in the chamber 140 rises, the stem 110 can be difficult to stroke. The compressible bladder 200 can compress to reduce the pressure in the chamber, wherein easing the task of stroking the stem 110, or moving the plug 125. The compressible bladder 200 can be placed in a position as to not interfere with the stem 110 of the valve 100.

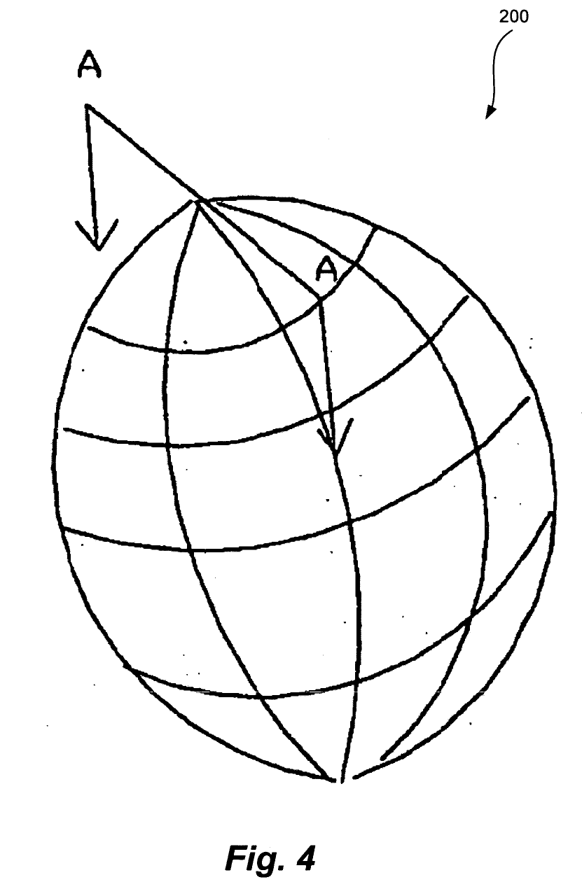

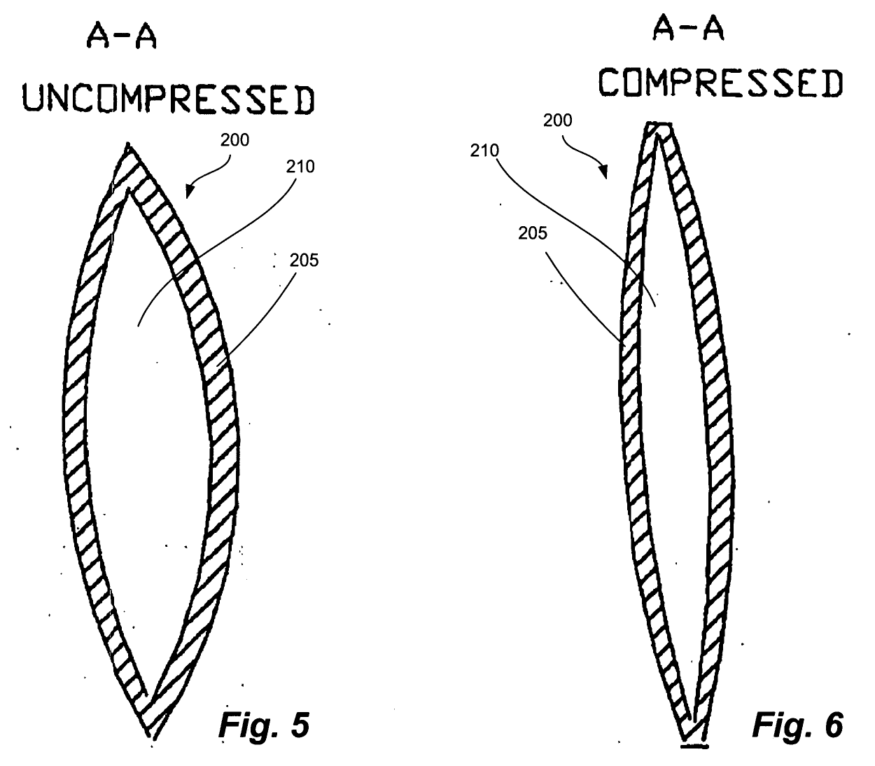

FIG. 4 illustrates a new way to relieve such pressure, which is superior to conventional methods. FIG. 5 illustrates a cross-sectional view along A-A of the bladder of FIG. 4 depicting the compressible bladder in an uncompressed state, in accordance with an exemplary embodiment of the present invention. FIG. 6 illustrates a cross-sectional view along A-A of FIG. 4 depicting the compressible bladder in a compressed state, in accordance with an exemplary embodiment of the present invention.

Referring to FIGS. 4-6, the compressible bladder 200 can include a shell 205 and a non-interfering assembly, which can be a connection assembly 215. The shell 205 defines a hollow interior 210 that is adapted to compress based on a predetermined amount of pressure within the chamber 140. Preferably, the interior 210 of the shell 205 is filled with compressible media, which can be different from the media flowing through the valve. The connection assembly 215 is adapted to secure the shell 205 within the chamber 140 of the bonnet 120 in a position as to not interfere with movement of the stem 110.

The shell 205 can comprise different materials. In an exemplary embodiment, the shell 205 can be made of stainless steel. Stainless steel is selected in this exemplary embodiment because it has strong characteristics, and can be designed to have a thin layer. The material used for the shell 205 of the compressible bladder 200 should provide some movement or flexibility, but not move plastically. Preferably, the material of the shell 205 can be able to compress. Typically, the shell 205 of the compressible bladder 200 can be composed of metal, plastic, a composite thereof, and the like.

The size of the compressible bladder 200 can range in size from a few square centimeters to numerous square meters, depending on the size of the pressure-locked chamber that is to be balanced. The application and area determine the size of the compressible bladder 200. Likewise, the volume of the compressible bladder 200 is dependent on the size needed.

The compressible bladder 200 can be many shapes. For example, the compressible bladder 200 can have a spherical, oval, convex, or bi-convex shape.

The compressible bladder 200 can also be considered a collapsible bladder, a gate valve pressure lock, or a clamshell. The compressible bladder 200 can perform as if a permanent air bubble were included in the sealed chamber 140. Accordingly, if the air bubble were to be included in the chamber 140, the pressure could be reduced as the air bubble could compress to permit enough media to slip out of the chamber 140. Thus, the compressible bladder 200 enables the opening of the valve 100, via the stem 110, even if the chamber 140 is full and an elevated temperature or pressure is attained. Typically, due to the increase in pressure, the stem 110 could not move and thus the disc 125 could not be removed from the valve body 105. The compressible bladder 200 can ease the task of opening the valve body 105, by being able to compress.

The interior 210 of the compressible bladder 200 can be filled with a low density gas. For instance, the interior 210 can include helium, hydrogen, argon, nitrogen, oxygen, and the like.

The gas in the interior 210 is compressed in the compressible bladder 200 when media in the chamber 140 pressurizes, but the gas in the interior 210 of the compressible bladder 200 is not released, just compressed; the mass of gas in the interior 210 does not change, i.e., no gas is released or captured in the compression. The gas is compressed by the increasing external pressure from increasing temperature/pressure in the chamber 140. The volume of the compressible bladder is decreased by the external pressure caused by increased pressure/temperature, and thus limits the external pressure around it in the closed volume. The chamber 140 is a closed volume, because it is sealed. When the limited external pressure is relieved, but the disc 125 unplugging the valve body 105, the gas expands, and the compressible bladder 200 returns to it original volume, and uncompressed state. Consequently, the compressible bladder 200 is ready to perform this compression and expansion many times, as is necessary. The shell 205 of the compressible bladder 200 is not strained plastically, and thus will return to its original shape when the pressure source is removed.

FIG. 5-6 illustrates volume change between the compressed state (FIG. 6) and the uncompressed state (FIG. 5) indicating that the pressure will not rise significantly in the chamber 140.

The compressible bladder 200 can be secured to an interior of the chamber 140 with the connection assembly 215. The connection assembly 215 can include a means of welding, bonding, bolting, and the like the compressible bladder 200 to the interior of the chamber 140. In a preferred embodiment, the compressible bladder 200 is positioned in a location as to not interfere with the insertion and removal of the disc 125 via the stem 110; that is, the compressible bladder 200 is positioned as to not interfere with the stem 115. The connection assembly 215 can include a bolt and an extending member defining a hole to receive the bolt, wherein the bolt is driver through the hole of the extending member into the interior of the chamber 140.

In an exemplary embodiment, the compressible bladder 200 can be placed into the chamber 140. For instance, the compressible bladder 200 can be placed in area P2. As a result of the rise in pressure the compressible bladder 200 changes from an uncompressed state (see FIG. 5) to a compressed state (see FIG. 6). The compressible bladder 200 can compress because of the material that it is made up of (e.g., thin stainless steel), and because it is filled with an easily compressible gas.

The rising pressure in P2 consequently compresses the compressible bladder 200. The rise in pressure in area P2 is limited. The compressible bladder 200 does not permit the pressure in the given area housing (i.e., the chamber 140 or area P2) to build to any appreciable value. Thus, in an exemplary embodiment, the compressible bladder 200 enables the valve to open through a range of chamber 140 pressures and not pressure lock.

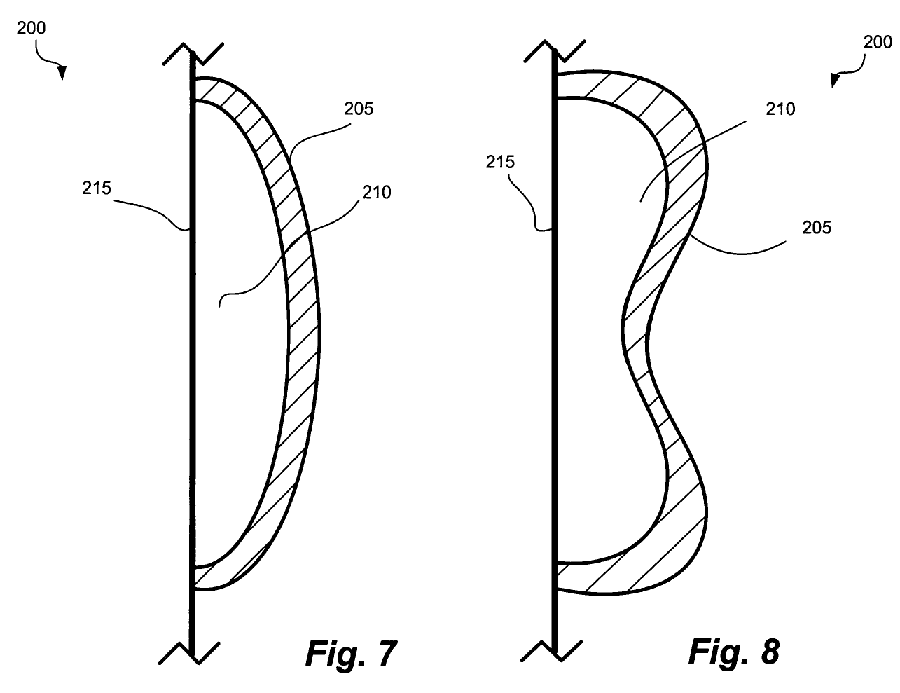

FIG. 7 illustrates the compressible bladder in an uncompressed state having a convex shape secured to a chamber, in accordance with an exemplary embodiment of the present invention. In an exemplary embodiment, the compressible bladder 200 can have a convex shape, such that the interior 210 is formed from the shell 205 and the interior of the chamber 140. The compressible bladder 200 can compress based on pressure in the chamber 140. FIG. 8 illustrates the compressible bladder in a compressed state secured to a chamber, in accordance with an exemplary embodiment of the present invention.

In another exemplary embodiment, a number of compressible bladders 200 can be in provided in the chamber 140. In total, a plurality of compressible bladders 200 can compress to cumulatively reduce the pressure in the chamber 140.

From the foregoing, it can be seen that the invention provides a number of different compressible bladders, which can be in a valve. The various embodiments of the invention described above provide improved and easy opening in a pressure sealed chamber, when compared with conventional approaches. Additionally, according to various embodiments of the invention, the compressible bladder can be provided with a shell having an interior that is securable to an interior of the sealable chamber. Unlike prior approaches, the compressible bladder locks the pressure in the valve, and eases opening a pressure-sealed chamber.

It will be appreciated by those skilled in the art, however, that the invention can be embodied in other specific forms without departing from the spirit or essential characteristics thereof. For example, while the invention has been described in the context of compressible bladder in a valve setting, the concepts described herein need not be limited to these illustrative embodiments. For example, compressible bladders can be used in other embodiments to control the amount of pressure in the pressure-sealed chamber, and would enjoy the same benefits as the compressible bladder in valves, as described above.

Additionally, the specific configurations, choice of materials, and the size and shape of various elements, can be varied according to particular design specifications or constraints requiring a bladder as constructed according to the principles of the invention. Such changes are intended to be embraced within the scope of the invention.

The presently disclosed embodiments are, therefore, considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A compressible bladder for minimizing pressure in a closed valve, the valve including a valve body, a bonnet defining a chamber, and a stem adaptable to travel within the bonnet, the compressible bladder comprising:
a shell defining a hollow interior, the shell adapted to compress through a range of pressures within the chamber; and
a non-interfering assembly for locating the shell within the chamber of the bonnet as to not interfere with movement of the stem.

2. The compressible bladder according to claim 1, wherein the valve is easier to open via the stem because of the lower pressure in the chamber of the bonnet caused by the compression of the shell.

3. The compressible bladder according to claim 1, wherein upon pressurizing the bonnet, the shell compresses to permit easier opening of the valve via the stem.

4. The compressible bladder according to claim 1, wherein media contained in the shell is a low pressure gas selected from the group consisting of nitrogen, helium, oxygen, carbon dioxide, and argon.

5. The compressible bladder according to claim 1, wherein the shell defines a bi-convex shape and is connected to an interior wall of the chamber.

6. The compressible bladder according to claim 1, wherein the shell defines a convex shape and is connected to an interior wall of the chamber.

7. The compressible bladder according to claim 1, wherein the non-interfering assembly is a connection assembly for securing the shell inside the chamber of the bonnet.

8. The compressible bladder according to claim 8, wherein the connection assembly is selected from the group consisting of bolting, welding, and bonding.

9. A valve comprising:
a valve body having an interior, wherein media is adapted to flow therethrough;
a bonnet defining a chamber carried by the valve body;
a plug having an open position and a closed position;
an elongated stem adapted to move the plug between the two positions, wherein the stem is positioned between the valve body and the bonnet; and
a compressible bladder positioned in the chamber of the bonnet adapted to compress upon an increase of pressure within the chamber of the bonnet.

10. The valve according to claim 9, wherein the compressible bladder includes a shell defining a hollow interior, the shell adapted to compress through a range of pressures within the chamber; and a connection assembly for positioning the shell within the chamber of the bonnet as to not interfere with movement of the stem.

11. The valve according to claim 10, wherein the interior of the shell includes compressible media.

12. The valve according to claim 10, wherein the compressible bladder is secured to an interior of the chamber of the bonnet via the connection assembly.

13. The valve according to claim 9, wherein the compressible bladder has a shape selected from the group consisting of substantially circular, oval, convex, and bi-convex.

14. In a method of relieving pressure in a bonnet chamber of a valve, the method comprising (i) pressurizing the bonnet chamber to a pressure wherein a stem of the valve can not be raised through the bonnet chamber, (ii) drilling a relief hole into the bonnet chamber to relieve the pressure, wherein causing media carried in the bonnet chamber to exit, wherein the improvement comprises providing a compressible bladder positioned in the bonnet chamber, wherein the compressible bladder is compressible based on increased pressure in the sealed bonnet chamber, and wherein the step of drilling a relief hole in the bonnet is removed.

15. The improved method according to claim 12, further including the step of compressing the compressible bladder in the pressure-sealed chamber based on an increase in pressure.

16. The improved method according to claim 13, further including the step of decompressing the compressible bladder based on an opening of the chamber and depressurizing of the chamber.
